(19) United States
(12) Patent Application Publication
(10) Pub. No.: US 2017/0038019 A1
(43) Pub. Date: Feb. 9, 2017

(54) Lampshade And Luminaire Using same

(71) Applicant: Shi Qiang Yuan, Zhongshan (CN)

(72) Inventor: Shi Qiang Yuan, Zhongshan (CN)

(21) Appl. No.: 14/819,753

(22) Filed: Aug. 6, 2015

(51) Int. Cl. F21S 10/02; F21V 5/04; F21V 7/04; F21V 1/00

(52) U.S. Cl. CPC F21S 10/02; F21V 1/00; F21V 5/04; F21V 7/04; F21Y 2101/02

(57) ABSTRACT

An improved luminaire connects a light-redirecting layer between a fixture body and a lampshade to eliminate the need for shielding plates. Illumination sources mounted to the fixture body emit light that is aimed at the light-redirecting layer. The light redirecting layer, for example a plurality of faceted ornaments such as rhinestones, reflects and refracts the light. The light ultimately leaves the luminaire through the transparent lampshade. The reflections and refractions caused by the light-redirecting layer create a visually appealing multicolored effect which changes according to the viewing angle of an observer. The improved luminaire provides increased efficiency, decreased light loss, and improved quality of lighting as compared to luminaires that use a shielding plate.

### FIELD OF THE INVENTION

The present invention relates generally to an improved lampshade for a luminaire which reduces glare and creates a colorful effect by reflecting and refracting light through a layer of faceted ornaments such as rhinestones.

### BACKGROUND OF THE INVENTION

Existing luminaires generally include both a lamp and a lampshade. A shielding plate is also used in order to reduce glare and improve the ornamental aspects of the luminaire. The shielding plate is commonly formed by a white semi-transparent film or by blasting sand and spraying paint on the surface of the lampshade or by using a semi-transparent material for the lamp shade. The shielding plate is usually installed between the lamp and the lampshade, such that the spots of the lamp cannot be seen on the lampshade. However, there are drawbacks to the use of a shielding plate, including more luminous efficacy loss (e.g. at least 30%-40%). Therefore, the energy-savings are impacted and the quality of the illumination effect is reduced. Additionally, after the shielding plate is added, the texture and grade of the lamp shade cannot be improved.

### SUMMARY

It is an object of the present invention to provide a lampshade which has simple structure and is used with a luminaire, irradiating light from a plurality of illumination sources directly onto a light-redirecting layer for multiple reflections and refractions. The light-redirecting layer is formed by a plurality of faceted ornaments such as rhinestones, the facets being used to produce colorful illumination effects. The colorful light then penetrates through the lampshade, as the lampshade is transparent. This negates the need for shielding plates, reduces light loss, increases energy savings, and creates a colorful light that highlights the texture of the lampshade and improves the ornamental nature and product grade of the present invention.

The light-redirecting layer (i.e. the plurality of faceted ornaments which are rhinestones) is connected atop the lampshade, such that the light-redirecting layer is positioned between the lampshade and the plurality of illumination sources.

A lamp shade comprises a transparent body having a thickness more than 8mm at least, wherein a rhinestone layer is paved on the top end surface of the transparent body; and the rhinestone layer at least comprises multiple rhinestones, the surfaces of which have a plurality of facets. The size and arrangement of each of the plurality of rhinestones, as well as the number of facets, is variable. Likewise different material constructions can be used for the plurality of rhinestones.

The shape of the lampshade is similarly variable, and can be chose from a variety of shapes including cylinders, circular columns, conoids, and other prisms. The lampshade is preferably transparent to allow for the transmission of light. Compared with existing art, the present invention is advantageous in that the need for shielding plates is negated as a result of the light-redirecting layer, which reduces glare, minimizes light loss, improves energy saving, and produces a colorful light. The light-redirecting layer is easily connected to the lampshade, such as by glue, which is used to easily install rhinestones on the lampshade.

The light from the illumination source passes through the light-redirecting layer (which reflects and refracts said light) and the transparent lampshade, with the end result being a stereoscopic multicolored effect. The effect is achieved through the multiple surface reflections (related to the facets) of the rhinestones, as well as the mutual refractions of the transparent lampshade.

The resulting stereoscopic multicolored effect is noticeably different from various viewing angles, due to the reflection and refraction of light. This is in comparison to the prior art, which emit a lighting effect that is substantially the same regardless of viewing angle. The faceted ornaments are capable of creating different lustres and decorative effects as light is reflected and refracted through said faceted ornaments, resulting in an improved product grade.

A fixture body is made of an opaque material, such as a metallic material, to ensure that light from the illumination sources is focused towards the faceted ornaments on a light-redirecting layer. A circuit board can also be provided to help with fixation and heat dissipation.

### BRIEF DESCRIPTION OF THE DRAWINGS

FIG. 1 is a perspective exploded view showing a fixture body and lampshade of the present invention.

FIG. 2 is a front exploded view showing the fixture body and lampshade of the present invention.

FIG. 3 is a bottom perspective view of the fixture body of the present invention.

FIG. 4 is a perspective view of the fixture body of the present invention.

FIG. 5 a bottom view of the fixture body of the present invention.

FIG. 6 is a perspective view of the lampshade with a light-redirecting layer of the present invention.

FIG. 7 is a top view of the lampshade and light-redirecting layer of the present invention.

FIG. 8 is a front section view of the lampshade and light-redirecting layer of the present invention.

FIG. 9 is an illustration of potential faceted ornaments that can be used for the light-redirecting layer.

### DETAIL DESCRIPTIONS OF THE INVENTION

All illustrations of the drawings are for the purpose of describing selected versions of the present invention and are not intended to limit the scope of the present invention.

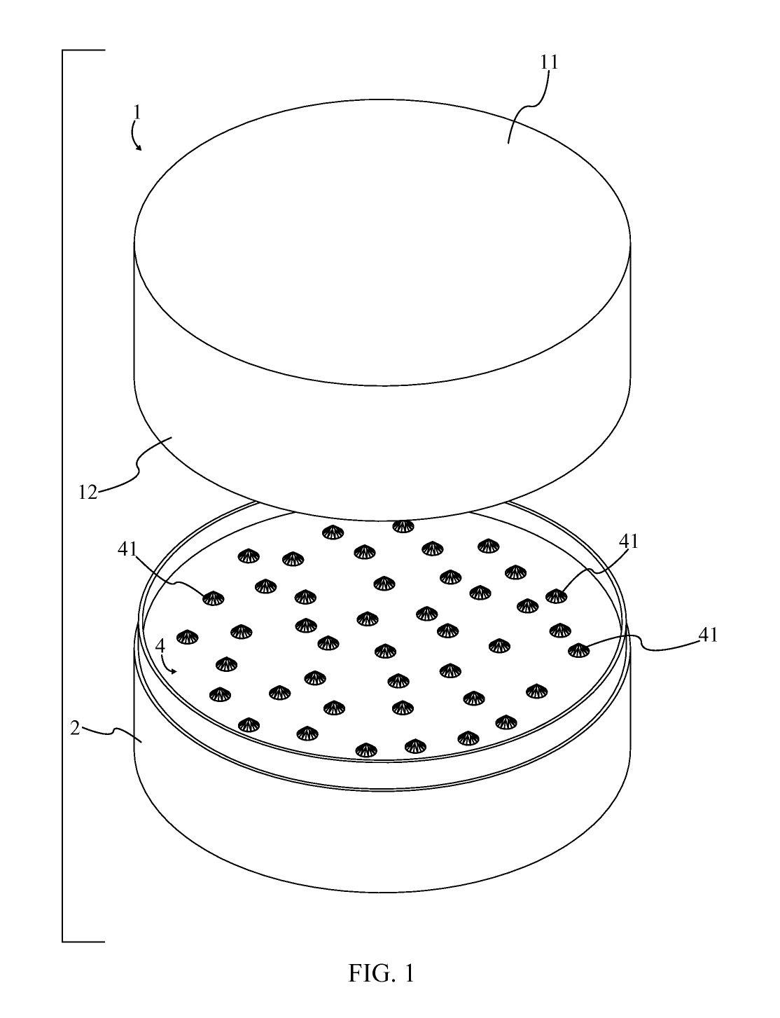

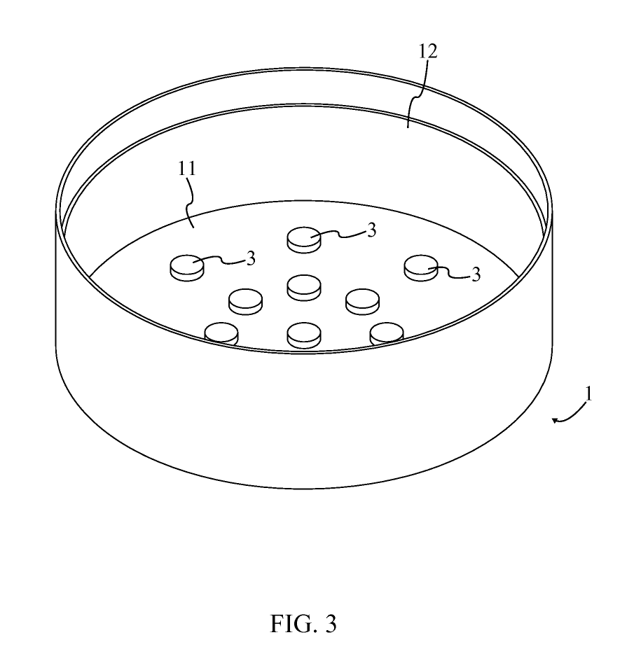

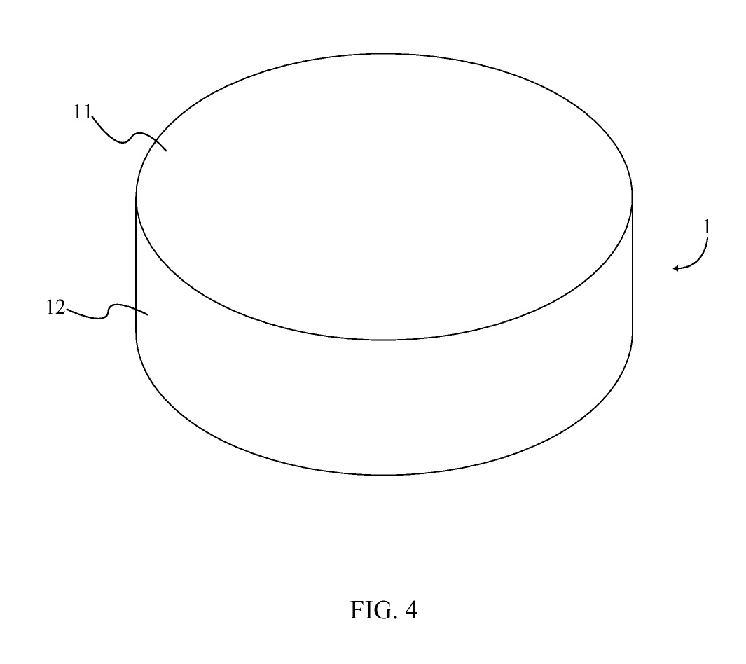

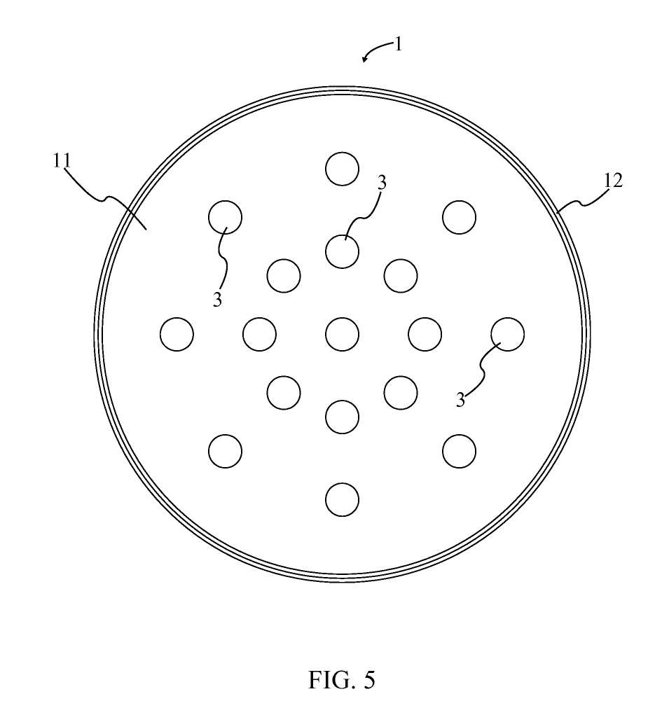

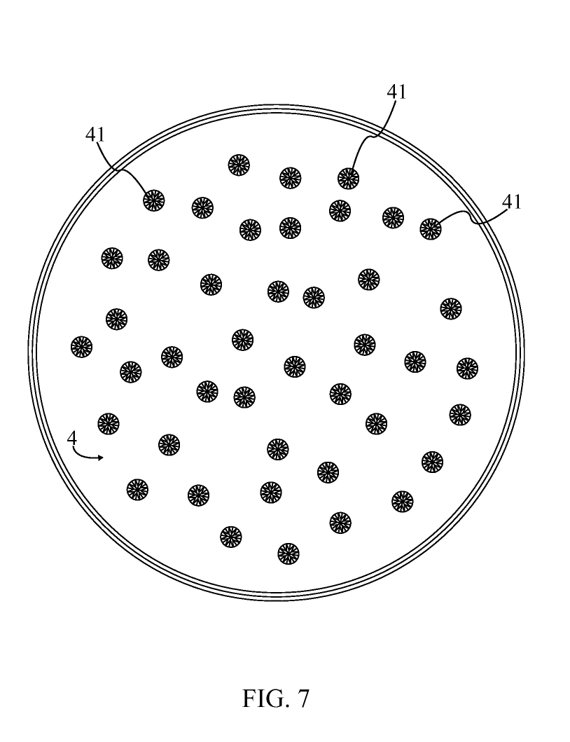

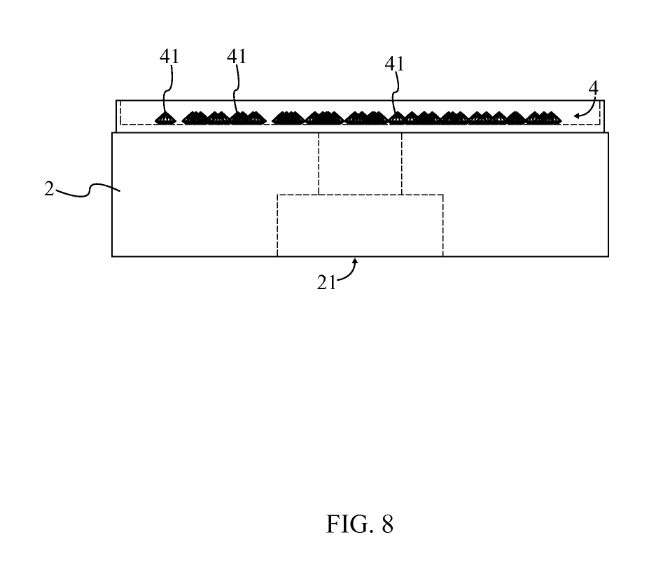

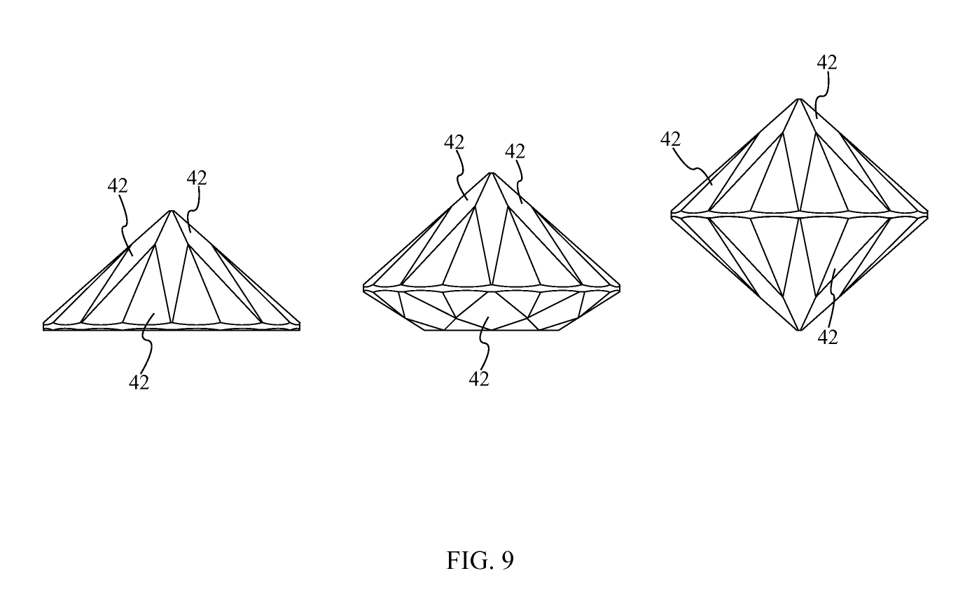

The present invention is a lighting fixture which provides a novel approach to shielding generated illumination while creating colorful illumination effects with minimal light loss and improved energy efficiency. To this end, the present invention comprises a fixture body 1, a lampshade 2, a plurality of illumination sources 3, and a light-redirecting layer 4. The lampshade 2 is adjacently attached to the fixture body 1, with the fixture body 1 serving as a housing for the plurality of illumination sources 3. The light-redirecting layer 4 is attached between the fixture body 1 and lampshade 2, allowing it to both refract and reflect light generated by the plurality of illumination sources 3. The plurality of illumination sources 3 directly irradiate the light-redirecting layer 4 in order to produce the desired colorful illumination effects. The present invention is illustrated via FIG. 1-FIG. 8, with FIG. 9 showing potential rhinestone shapes and patterns.

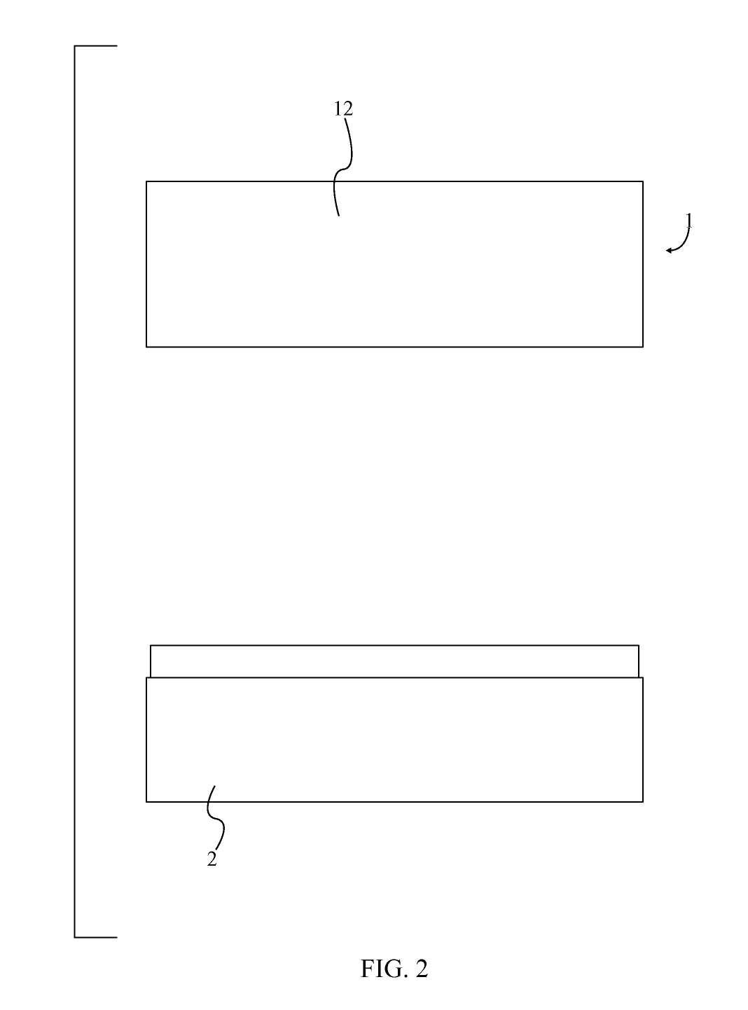

The light-redirecting layer 4 itself is able to both reflect and refract light originating from the plurality of illumination sources 3. Whether light is reflected or refracted depends on the angle of incidence of the generated light. The light-redirecting layer 4 comprises a plurality of faceted ornaments 41 which allow for the reflection and refraction of light. Each of the faceted ornaments 41 comprises a plurality of facets 42. Facets 42 are the surfaces that reflect or refract the light that passes from the plurality of illumination sources 3. In the preferred embodiment, the plurality of faceted ornaments 41 is a plurality of rhinestones, i.e. ornamentations with characteristics which are similar to diamonds. Rhinestones are obtained by cutting material (such as artificial glass) into diamond facets 42, allowing the rhinestone to serve as a diamond substitute. The rhinestones are connected are arranged in a layer between the fixture body 1 and the lampshade 2, positioning themselves between the plurality of illumination sources 3 and the lampshade 2. By reflecting and refracting light, the rhinestones not only negate the need for a shielding plate, they also increase aesthetical appeal via the resulting colorful illumination effects. In order to ensure that light from the plurality of illumination sources 3 reaches the light-redirecting layer 4, the fixture body 1 is preferably opaque. The opaque construction prevents light from escaping through the fixture body 1, instead channeling the light towards the light-redirecting layer 4. The fixture body 1 can be made from a metallic construction, which is just one example of a material that can be used to provide the desired opaque quality. The relation between the fixture body 1, lampshade 2, and light-redirecting layer 4 is best shown through the exploded views of FIG. 1 and FIG. 2.

The exact number of the plurality of faceted ornaments 41 is not restricted by the present invention; different embodiments can use as many or as few faceted ornaments 41 as is desired. Likewise, while the preferred embodiment describes a single light-redirecting layer 4, other embodiments might choose to stack multiple light-redirecting layers 4. Such an embodiment would provide more opportunities for light to be reflected and refracted as it passes through each light-redirecting layer 4.

In the illustrated embodiment, the plurality of faceted ornaments 41 (e.g. rhinestones) is directly connected to the top of the lampshade 2. The manner in which the plurality of faceted ornaments 41 is connected to the lampshade 2 can vary; in one embodiment the plurality of faceted ornaments 41 is paved onto a top surface of the lampshade 2 via the use of an adhesive paste such as glue. In another embodiment, the plurality of faceted ornaments 41 can be adhered to a separate body, with the separate body then being connected atop the lampshade 2. These are just a few examples of how the light-redirecting layer 4 can be integrated into the present invention and do not preclude the use of other methods.

The arrangement of the plurality of faceted ornaments 41 is also variable. The plurality of faceted ornaments 41 can potentially be arranged in a specific pattern, or alternatively be irregularly positioned across the top of the lampshade 2. The faceted ornaments 41 themselves may be of uniform shape and size or a variety of differently shaped and sized faceted ornaments 41 may be used.

The combination of the light-redirecting layer 4 and the fixture body 1 effectively creates a chamber within the fixture body 1, the chamber being delineated by the base surface 11, the lateral surface 12, and the light-redirecting layer 4. The base surface 11 and lateral surface 12 are opaque, meaning light can only be transmitted through the light-redirecting layer 4. The passing of light through the light-redirecting layer 4 creates an aesthetically pleasing colorful illumination effect, which is emitted through the lampshade 2.

The exact number of facets 42 used for each of the plurality of faceted ornaments 41 is variable. The higher the number of facets 42, the more surfaces there are that can reflect and refract light, resulting in an increase of the aesthetical appeal of the present invention. For example, the specific number of facets 42 could be as low as two, or even as high as thirty for a Swarovski rhinestone.

Different embodiments can use different materials as the plurality of rhinestones, with corresponding advantages and disadvantages. Examples of potential rhinestones include glass, artificial spinel, artificial sapphire, quartz, topaz, zircon, and cubic zirconia. Plastic is another material that could potentially be used. These are just a few examples of possible implantations, with other implementations being possible under the scope of the present invention. These provided examples are subsequently described in more detail. Regardless of the type of diamond substitute used, rhinestones commonly have eight sections, with a layer of mercury being plated on the back of the rhinestone. Condensation of each section results in the rhinestone having very good brightness.

Glass is, compared to some other choices, an inexpensive option for the plurality of rhinestones. However, glass has a low refraction rate and does not have the twinkling rainbow light exhibited by a true diamond, and as such may be unsuitable in the eyes of some potential consumers.

Drawbacks of artificial spinel include its lack of a twinkling rainbow light, as seen with a true diamond. Additionally, when immerged into diiodomethane, the outline of artificial spinel is blurred whereas the outline of a true diamond remains sharp. Artificial sapphire suffers from a similar drawback; when artificial sapphire is immerged in diiodomethane it nearly vanishes, making it easily distinguishable from a true diamond.

Quartz and topaz appear similar to diamonds after being polished, but lack the bright lustre of a true diamond. Furthermore, both can be distinguished from true diamonds through use of a polariscope, as the former are “heterogeneous bodies” while diamonds are “homogeneous bodies”.

Zircon, the optimal diamond substitute prior to cubic zirconia, imitates true diamonds in many ways. Zircon has very strong birefringence (i.e. it has two refractive indices) with a large difference between the two indices.

Cubic zirconia is the ideal diamond substitute, being very close to true diamonds in many ways including refractive index and dispersion. Cubic zirconia is not a perfect imitation, though, as the hardness of cubic zirconia is lower than a diamond (8.5 compared to 10) and the specific weight is greater, around 1.6-1.7 times the specific weight of diamonds.

Potentially, true diamonds can be used for the light-redirecting layer 4, though such an embodiment would be more costly than one using rhinestones. To reduce the added cost of using true diamonds, artificially created diamonds (i.e. “synthetics”) can be used in place of naturally formed diamonds.

Just as different types of materials are possible for the light-redirecting layer 4, so are different cuts for the plurality of faceted ornaments 41. Examples of these include the earlier referenced Swarovski rhinestones, Czech rhinestones, Korea rhinestones, homegrown grade-A rhinestones, and homegrown grade-B rhinestones. Swarovski rhinestones, thanks to their high number of facets 42, have an extremely high refractive index which creates a deep feeling. Furthermore, the high hardness means the lustre of a Swarovski rhinestone is resilient. Czech rhinestones have dozens of facets 42 and as a result have refractions with a bright shining light. The hardness of the Czech rhinestone is respectable, though not as high as a Swarovski rhinestone. The lustre of a Czech rhinestone lasts for about 3 years, which is greatest of the non-Swarovski rhinestone options. Other produced rhinestones are commonly low cost options produced to meet mass market demands and have a quality which is lower than that of the Czech and Swarovski rhinestones.

Rhinestones can be further classified by color. For example, rhinestones may be referred to as white diamond, colored diamond (e.g. pin, red, and blue), colorful diamond (also called AB diamond), and colored AB diamond (e.g. red AB or blue AB). Rhinestones can also be classified based on shapes of different surfaces; examples include sharp bottom diamond and flat bottom diamond (referring to the shape of a bottom surface of the individual rhinestone) and common diamond and heteromorphic diamond (referring to the shape of a facet 42). The heteromorphic classification can be further divided into classes such as rhombus diamond (horse's eye), trapezoid diamond, rivoli stones, water-drop shape diamond, oval diamond, octagon diamond, and more.

The fixture body 1 itself comprises a base surface 11 and a lateral surface 12. The lateral surface 12 forms a wall around the base surface 11, with the lateral surface 12 being perimetrically connected to the base surface 11. The base surface 11 serves as a connection point for the plurality of illumination sources 3, which are adjacently connected to the base surface 11. The plurality of illumination sources 3 are positioned interior to the lateral surface 12, which laterally encloses said plurality of illumination sources 3. As a result, the fixture body 1 is closed off at the top and sides, with light only able to escape out the bottom (where the light-redirecting layer 4 is positioned). The fixture body 1 is preferably opaque in order to ensure that light is not transmitted through the base surface 11 or lateral surface 12 of the fixture body 1, which would reduce the amount of light passing through the light-redirecting layer 4 and correspondingly increase the amount of glare. The components of the fixture body 1 are best shown in FIG. 1-FIG. 5.

In the preferred embodiment, the plurality of illumination sources 3 is a plurality of light-emitting diodes (often referred to as LEDs). However, other embodiments of the present invention may utilize different components as the illumination sources 3; LEDs are just one example of a potential illumination source 3 for the present invention. The lampshade 2 is positioned adjacent to the fixture body 1, and is connected to the light-redirecting layer 4 opposite the fixture body 1. In the preferred embodiment the lampshade 2 is transparent, such that light that has been reflected and refracted through the light-redirecting layer 4 can pass through the lampshade 2. Examples of materials used for construction of such a transparent lampshade 2 include, but are not limited to, glass and acrylic material. The specific shape of the lampshade 2 is variable; while it is shown as being cylindrical in the illustrated embodiment, other possible shapes include conoids and other prisms (e.g. a tri-prism) or geometric objects.

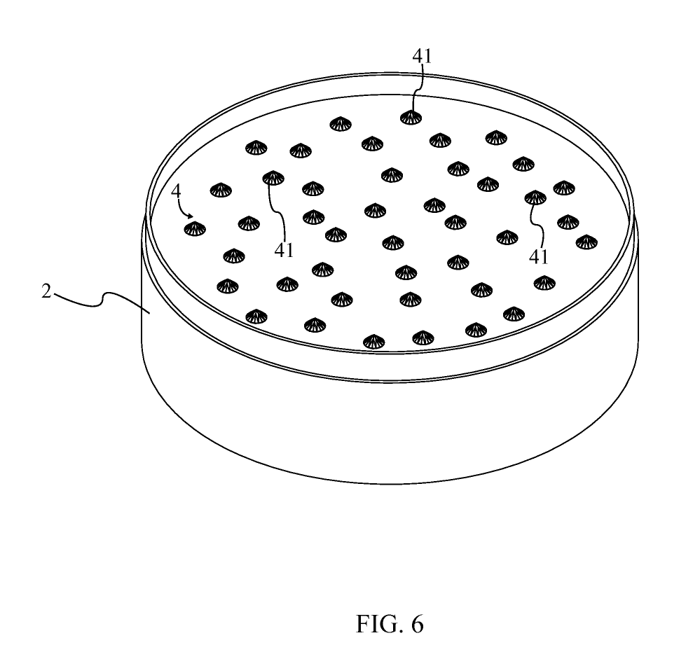

Preferably, a cavity 21 traverses into the lampshade 2 towards the light-redirecting layer 4. The cavity 21 allows light to be pass through the light-redirecting layer 4 and out of the lampshade 2 without having to pass through the body of the lampshade 2. The cavity 21 will also cause additional reflection and refraction of light based on the angle of incidence of light passing through the light-redirecting layer 4 into the lampshade 2. The lampshade 2, along with cavity 21, are illustrated in FIG. 1, FIG. 2, and FIG. 6-FIG. 8.

Examples of possible dimensions for components of the present invention include a minimum thickness of 8 mm for the lampshade 2 and a rhinestone diameter in the range of 1.8 mm to 8 mm. The distance between the plurality of illumination sources 3 and the light-redirecting layer 4 ranges from 15 mm to 60 mm. While these dimensions have been found to produce optimal illumination effects, ultimately any dimensions can be used while remaining within the scope of the present invention.

Although the invention has been explained in relation to its preferred embodiment, it is to be understood that many other possible modifications and variations can be made without departing from the spirit and scope of the invention as hereinafter claimed.

What is claimed is:

1. A lighting fixture comprises:
a fixture body;
a lampshade;
a plurality of illumination sources;
a light-redirecting layer;
the lampshade being adjacently attached to the fixture body;
the plurality of illumination sources being housed within the fixture body; and
the light-redirecting layer being attached between the fixture body and the lampshade.

2. The lighting fixture as claimed in claim 1, wherein the light-redirecting layer reflects light.

3. The lighting fixture as claimed in claim 1, wherein the light-redirecting layer refracts light.

4. The lighting fixture as claimed in claim 1 comprises:
the light-redirecting layer comprises a plurality of faceted ornaments.

5. The lighting fixture as claimed in claim 4 comprises:
the plurality of faceted ornaments being adjacently connected atop the lampshade.

6. The lighting fixture as claimed in claim 4 comprises:
the plurality of faceted ornaments being a plurality of rhinestones.

7. The lighting fixture as claimed in claim 4 comprises:
each of the plurality of faceted ornaments comprises a plurality of facets.

8. The lighting fixture as claimed in claim 1 comprises:
the fixture body comprises a base surface and a lateral surface;
the lateral surface being perimetrically connected to the base surface; and
the plurality of illumination sources being adjacently connected to the base surface.

9. The lighting fixture as claimed in claim 8 comprises:
the lateral surface being positioned around the plurality of illumination sources.

10. The lighting fixture as claimed in claim 1 comprises:
a cavity; and
the cavity traversing into the lampshade towards the fixture body.

11. The lighting fixture as claimed in claim 1 comprises:
the plurality of illumination sources being a plurality of light-emitting diodes.

12. The lighting fixture as claimed in claim 1 comprises:
the plurality of illumination sources being oriented towards the light-redirecting layer, wherein light emitted from the plurality of illumination sources is directly irradiated on the light-redirecting layer.

13. The lighting fixture as claimed in claim 1 comprises:
the lampshade being transparent.

14. A lighting fixture comprises:
a fixture body;
a lampshade;
a plurality of illumination sources;
a light-redirecting layer;
a cavity;
the fixture body comprises a base surface and a lateral surface;
the light-redirecting layer comprises a plurality of faceted ornaments;
the lampshade being adjacently attached to the fixture body;
the plurality of illumination sources being housed within the fixture body;
the plurality of illumination sources being oriented towards the light-redirecting layer, wherein light emitted from the plurality of illumination sources is directly irradiated on the light-redirecting layer;
the light-redirecting layer being attached between the fixture body and the lampshade;
the plurality of faceted ornaments being adjacently connected atop the lampshade;
the cavity traversing into the lampshade towards the fixture body; and
the lampshade being transparent.

15. The lighting fixture as claimed in claim 14, wherein the light-redirecting layer reflects light.

16. The lighting fixture as claimed in claim 14, wherein the light-redirecting layer refracts light.

17. The lighting fixture as claimed in claim 14 comprises:
the plurality of faceted ornaments being a plurality of rhinestones.

18. The lighting fixture as claimed in claim 14 comprises:
each of the plurality of faceted ornaments comprises a plurality of facets.

19. The lighting fixture as claimed in claim 14 comprises:
the lateral surface being perimetrically connected to the base surface;
the plurality of illumination sources being adjacently connected to the base surface; and
the lateral surface being positioned around the plurality of illumination sources.

20. The lighting fixture as claimed in claim 14 comprises:
the plurality of illumination sources being a plurality of light-emitting diodes.
